(19) United States
(12) Patent Application Publication
(10) Pub. No.: US 2025/0385323 A1
(43) Pub. Date: Dec. 18, 2025

(54) BATTERY MODULE, METHOD FOR PROVIDING MONITORING FUNCTIONALITY FOR THE SAME, BATTERY SYSTEM AND ELECTRIC VEHICLE

(71) Applicant: SAMSUNG SDI CO., LTD., Yongin-si (KR)

(72) Inventors: Fritz HARING, Bruck an der Mur (AT); Gerald KNOLLSEISEN, Graz (AT); Matic BLAZNIK, Maribor (SI)

(21) Appl. No.: 18/967,387

(22) Filed: Dec. 3, 2024

(30) Foreign Application Priority Data
Jun. 12, 2024 (EP) 24181611.5

(51) Int. Cl. H01M 10/42; B60L 50/64; H01M 10/48; H01M 10/653; H01M 50/204; H01M 50/581

(52) U.S. Cl. CPC H01M 10/425; B60L 50/64; H01M 10/482; H01M 10/486; H01M 10/653; H01M 50/204; H01M 50/581; H01M 2010/4271; H01M 2200/10; H01M 2220/20

(57) ABSTRACT

A battery module includes: a plurality of battery cells; a busbar contacting the plurality of battery cells; a thermally and electrically conductive bushing thermally and electrically connected to the busbar; and a circuit board fixed to the bushing by a fixation element such that the bushing spaces the circuit board from the busbar. The circuit board includes: a temperature sensor in thermal contact with the busbar through the bushing; and a voltage signal line in electrical contact with the busbar through the bushing.

### CROSS-REFERENCE TO RELATED APPLICATION

This application claims priority to and the benefit of European Patent Application No. 24181611.5, filed on Jun. 12, 2024, in the European Patent Office, the entire disclosure of which is incorporated herein by reference.

### BACKGROUND

### 1. Field

Aspects of embodiments of the present disclosure relate to a battery module, a method for providing monitoring functionality for the battery module, a battery system, and an electric vehicle.

### 2. Description of the Related Art

Recently, vehicles for transportation of goods and peoples have been developed that use electric power as a source for motion. An electric vehicle is an automobile that is propelled, permanently or temporarily, by an electric motor by using energy stored in rechargeable (or secondary) batteries. An electric vehicle may be solely powered by batteries (a so-called Battery Electric Vehicle or “BEV”) or may include a combination of an electric motor and, for example, a conventional combustion engine (a so-called Plugin Hybrid Electric Vehicle or “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (or accommodated in) a casing and electrode terminals, which are positioned on the outside of the casing, establish an electrically conductive connection to the electrodes. The shape of the casing may be, for example, cylindrical or rectangular.

A battery module is formed of a plurality of battery cells connected together in series or in parallel. For example, the battery module is formed by interconnecting the electrode terminals of the plurality of battery cells in a number and configuration depending on a desired amount of power and to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

A battery system may also include a battery management system (BMS), which is any suitable electronic system that is configured to manage the rechargeable battery cell, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery cell(s) as represented by voltage (e.g., a total voltage of the battery pack or battery modules and/or voltages of individual battery cells), temperature (e.g., an average temperature of the battery pack or battery modules, coolant intake temperature, coolant output temperature, or temperatures of individual battery cells), coolant flow (e.g., flow rate and/or cooling liquid pressure), and current. Additionally, the BMS may calculate values based on the above parameters, such as minimum and maximum cell voltage, state of charge (SoC) or depth of discharge (DoD) to indicate the charge level of the battery cell, state of health (SoH; a variously-defined measurement of the remaining capacity of the battery cell as % of the original capacity), state of power (SoP; the amount of power available for a defined time interval given the current power usage, temperature, and other conditions), state of safety (SoS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. In other examples, the BMS may be distributed, with a BMS board installed at each cell and only a single communication cable between the battery cell and a controller. In yet other examples, the BMS may have a modular construction including a few controllers, each handling (e.g., monitoring and/or controlling) a number of (or a group of) cells, while communicating between the controllers. Centralized BMSs are most economical but are least expandable and are plagued by a multitude of wires. Distributed BMSs are the most expensive but are simplest to install and offer the cleanest assembly. Modular BMSs provide a compromise between the other two topologies.

The BMS may protect the battery pack from operating outside its safe operating area. Operation outside the safe operating area may be indicated by over-current, over-voltage (during charging), over-temperature, under-temperature, over-pressure, and ground fault or leakage current detection. The BMS may prevent the battery from operating outside its safe operating parameter by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

A static control of battery power output and charging may not be sufficient to meet the dynamic power demands of various electrical consumers connected to the battery system. Thus, steady exchange of information between the battery system and the controllers of the electrical consumers may be used. This information includes the battery systems actual state of charge (SoC), potential electrical performance, charging ability and internal resistance as well as actual or predicted power demands or surpluses of the consumers. Therefore, battery systems usually include a battery management system (BMS) for obtaining and processing such information on a system level and may further include a plurality of battery module managers (BMMs), which are part of the system's battery modules and obtain and process relevant information on a module level. For example, the BMS usually measures the system voltage, the system current, the local temperature at different places inside the system housing, and the insulation resistance between live components and the system housing. Additionally, the BMMs usually measure the individual cell voltages and temperatures of the battery cells in a battery module.

Thus, the BMS is provided for managing the battery pack, such as by protecting the battery from operating outside its safe operating area, monitoring its state, calculating secondary data, reporting that data, controlling its environment, authenticating it, and/or balancing it.

In the event of (e.g., detection of) an abnormal operation state, a battery pack should be disconnected from a load connected to a terminal of the battery pack. Therefore, battery systems may further include a battery disconnect unit (BDU) that is electrically connected between the battery module and battery system terminals. The BDU is the primary interface between the battery pack and the electrical system of the vehicle. The BDU includes electromechanical switches that open or close high current paths between the battery pack and the electrical system. The BDU provides feedback to the battery control unit (BCU) accompanied to the battery modules, such as voltage and current measurements. The BCU controls the switches in the BDU using low current paths based on the feedback received from the BDU. The primary functions of the BDU may include controlling current flow between the battery pack and the electrical system and current sensing. The BDU may further manage additional functions, such as external charging and pre-charging.

The BMS is critical to the safe operation and optimal performance of rechargeable battery cells and helps reduce or minimize the possibility of thermal runaway. For example, if the BMS detects that the temperature is too high, it can regulate the temperature by controlling cooling fans. If the battery cell cannot be sufficiently cooled and safe conditions restored, the BMS may shut down necessary battery cells to protect the entire system.

For acquiring information of the battery cells in a battery module, the battery cells may be contacted by monitoring devices. One common method is to contact busbars, which connect multiple terminals of battery cells and which carry current of multiple battery cells. Key information is, for example, the temperature of the busbar and the voltage of the busbar. Inside conventional BDUs, temperature and high-voltage voltage sensing is used. The connections are provided as high-voltage cables for voltage sensing and flex prints for temperature sensors. Therefore, a complex assembly is required because the high-voltage cables and the flex prints have to be mounted. In other examples, conductive tabs have to be welded to the busbars. Further, electronics are usually screwed to the housing.

### SUMMARY

Embodiments of the present disclosure provide an improved connection structure for acquiring key information related to the battery cells.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery module includes a plurality of battery cells, a busbar contacting the plurality of battery cells, a thermally and electrically conductive bushing thermally and electrically connected to the busbar, and a circuit board connected to the bushing by a fixation element such that the bushing spaces the circuit board from the busbar. The circuit board includes a temperature sensor thermally connected to the busbar through the bushing and a voltage signal line electrically connected to the busbar through the bushing.

According to an embodiment of the present disclosure, a method for providing a monitoring functionality to the above-described battery module includes fixing the bushing to the busbar, placing the circuit board including the temperature sensor and the voltage signal line onto the bushing such that a board opening in the circuit board and the bushing are aligned, and fastening the bushing to the circuit board by the fixation element to electrically and thermally connect the busbar to the circuit board through the bushing.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic overview of a battery module according to an embodiment.

FIG. 2 is a schematic cross section of a bushing according to an embodiment.

FIG. 3A is a schematic cross section of a bushing according to another embodiment.

FIG. 3B is a schematic cross section of a bushing according to another embodiment.

FIG. 3C is a schematic cross section of a bushing according to another embodiment.

FIG. 4 is a perspective schematic view of a bushing between a busbar and a circuit according to an embodiment.

FIG. 5 is a graph showing a temperature change over time on a circuit board at a heat spot and at a remote temperature sensor.

FIG. 6 is a flow chart describing a method according to an embodiment.

FIG. 7 is a schematic view of a battery system according to an embodiment.

FIG. 8 is a schematic view of an electric vehicle according to an embodiment.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, such as on a PCB or another kind of circuit carrier. The conducting elements may include metallization, for example, surface metallizations and/or pins, and/or may include conductive polymers or ceramics. Further electrical energy might be transmitted via wireless connections, such as by using electromagnetic radiation and/or light.

According to an embodiment of the present disclosure, a battery module includes a plurality of battery cells, a busbar contacting the plurality of battery cells, a thermally and electrically conducting (or conductive) bushing that is thermally and electrically connected to (e.g., fixed to) the busbar, and a circuit board fixed to the bushing by a fixation element such that the bushing spaces the circuit board from the busbar. The circuit board includes a temperature sensor in thermal contact with the busbar through the bushing and a voltage signal line in electrical contact with the busbar through the bushing.

By applying the bushings to the busbars, an electrical connection from the busbars to the electronic is provided. All additional parts, such as high voltage (HV) cables for voltage sensing or flex prints (e.g., flexible printed circuit boards or FPCB) for temperature sensing are not required and are replaced by the bushings. An electrical and thermal connection is established via the connection of the bushing to the busbar.

The bushing may be made of a thermally and electrically highly conducting (or conductive) material. A thermally and electrically highly conducting material is characterized by low losses. For example, a thermally conducting material is characterized by exhibiting a relatively low temperature difference between two opposite ends along its longitudinal direction compared to other materials. Further, an electrically conducting material is characterized by having a relatively low electric potential difference between two opposite ends along its longitudinal direction compared to other materials. The busbar may be an electrically conducting longitudinally extending part for connecting terminals of a plurality of battery cells. The busbar may be made of metal. By directly connecting the bushing with the busbar, no additional parts for contacting the busbar are required.

The cross-sectional shape of the bushing may be round, square, elliptic, rectangular, hexagon, or any other suitable shape.

The busbar may also be, in sections, bent in a vertical direction. The circuit board may be a printed circuit board (PCB), a multiplayer PCB, and/or a flexible PCB. A comparatively thin PCB has the advantage that its temperature changes quickly, depending on its surrounding. In other words, thermal responsivity is improved. The circuit board may have a metallization around the connection point with the bushing. Metal is a good heat conductor and, therefore, the metallization may be thicker than in common circuit boards. In some embodiments, the metallization may only be thicker (e.g., may be locally thicker) in the vicinity of the bushing and the temperature sensor than in other regions of the circuit board. The temperature sensor may be an SMD sensor and may be arranged within a radius centered around a center of the bushing in a range of about 0.5 mm to about 4 mm. In some embodiments, the radius may be in a range of about 0.6 mm to about 1.5 mm. The closer the temperature sensor is to the bushing, the lower an error (or difference) in temperature measurement of the bushing and, consequently, the temperature measurement of the busbar. Temperature measurement may be limited to temperatures of about 140° C. In some embodiments, temperature measurement is limited to about 130° C. The voltage signal line may be made of an electrically conducting material having high conductivity to minimize losses along the voltage line. Thereby, exact measurement of the voltage of the busbar is possible. The bushing may be a solid body for spacing and connecting the busbar to the circuit board. The bushing may be partly hollow. The hollow portion of the bushing may be used by (e.g., may be engaged with) the fixation element for fixing the circuit board to the bushing. However, the bushing may also have a protruding portion extending through the circuit board. Then, the fixation element may interact with the protruding portion and thereby fix the circuit board to the bushing.

By fixing the circuit board to its designated mounting location in the battery module, electrical and thermal connection is concurrently established.

According to another embodiment, the bushing is fixed to the busbar in a form-fitting manner, in a force-fitting manner, and/or in a materially bonded manner.

The bushing may be fixed to the busbar in various ways. For example, the bushing may be fixed in a form-fitting manner. A form-fit may be provided by hooks on one part and corresponding holes (or openings) in the other part, which snap and connect when vertically moved together. In other embodiments, locking may be achieved by rotational movement of the bushing relative to the busbar.

In some embodiments, the bushing may be fixed in a force-fitting manner. This may be provided by press-fitting the bushing into an opening in the busbar. In other embodiments, the busbar may have multiple smaller through holes, in which protruding pins of the bushing can be press-fitted. In other embodiments, the busbar may include a protrusion on which the bushing can be press-fitted. The force-fit connection allows for heat to be conducted through a larger contact surface between both parts. Further, assembly is quick because no processing steps are required.

In some embodiments, the bushing may be fixed in a materially bonded manner. This may be provided, for example, by gluing, welding, or soldering. Because the contact surface is increased, heat transfer is improved.

All of the above fixing methods may be combined in any suitable variation.

According an embodiment, the circuit board has a thickness, and the bushing spaces the circuit board from the busbar by at least twice the thickness of the circuit board.

The spacing of the circuit board from the busbar prevents the circuit board from being heated by the busbar. The circuit board also includes other parts, which are sensitive to heat. Therefore, it is desirable to avoid or minimize heat transfer to the circuit board. For example, heat may only be transferred to the circuit board in the vicinity of the bushing and the temperature sensor. This may be provided by that the circuit board being configured to thermally isolate the region around the board opening from other circuit elements on the circuit board not directly related to the temperature and voltage measurement.

According to an embodiment, the bushing spaces the circuit board from the busbar by at least about 8 mm. In another embodiment, the spacing is at least about 10 mm. In one embodiment, the spacing is at least about 12 mm.

In an embodiment, the bushing has a bushing opening extending from a first end face of the bushing facing the circuit board towards the busbar.

The bushing opening may be blind (e.g., may be a blind hole or opening) and may not extend entirely through the bushing. The bushing opening may have an inner thread for holding a fixation element such as, for example, a screw. The cross-sectional shape of the bushing opening may be round or square or may be any other suitable shape. In one embodiment, the shape of the bushing opening corresponds to the shape of the bushing.

According to another embodiment, the bushing opening extends from the first end face to a second end face of the bushing opposite to the first end face.

For example, the bushing opening may be a through-hole.

In an embodiment, the bushing may be a hollow cylinder having a bushing opening.

The wall thickness of the bushing, in a cross-sectional view, at where the bushing opening is present may be between about 0.5 mm to about 3 mm. In some embodiments, the wall thickness may be between about 1 mm and about 2 mm. In one embodiment, the wall thickness is between about 1.3 mm and about 1.5 mm. The wall thickness may be constant for the entire bushing to facilitate ease of processing of the bushing. In other embodiments, however, the wall thickness may not be constant, for example, so the bushing can provide a form fit or for the fixation element. Further, a larger wall thickness has better thermal conductivity.

According an embodiment, the fixation element includes a screw, a bolt, a plug, a bolt, a nut, a splint, or a rivet.

In some embodiments, a portion of the fixation element is configured to be fixedly connected in the bushing opening.

In an embodiment, the circuit board forms part of a monitoring of a battery disconnect unit, a battery management unit, and/or a cell supervision circuit.

Due to the integration into one of the above units, reliable operation due to short signal distances and the elimination of interconnects is achieved.

According to an embodiment, a temperature difference between a section of the circuit board in direct contact with the bushing and a section of the circuit board in direct contact with the temperature sensor is less than about 1K. In another embodiment, the temperature difference is less than about 0.5K.

The bushing transfers heat from the busbar towards the circuit board. For example, the bushing is the heat source, which is attached to the circuit board and from which the heat spreads to the circuit board. The temperature difference is directed to the difference of temperature in the circuit board between the heat source and the temperature sensor, which represents a measurement error of the temperature sensor. Accordingly, a small temperature difference is favorable.

In an embodiment, the bushing is a metal bushing. Metal provides high thermal and electric conductivity as well as strength and elasticity, to, for example, withstand temporary stress during assembly. The metal may be selected from among stainless steel, aluminum, brass, copper, gold, silver, or any combinations or alloys thereof.

In other embodiments, the bushing may be made of carbon fiber. Carbon fiber is available with comparable features as metal regarding thermal and electrical conductivity. Carbon fibers may be coated with one of the metals described above. Thereby, the strength of carbon fibers may be combined with the high electric and thermal conductivity of metal.

According to an embodiment, the voltage signal line is a high voltage sensing line.

A high voltage sensing line does not carry significant current, that is, a very low current, sufficient to carry out voltage measurement. For example, the measurement may be a high-resistance voltage measurement. However, voltage sensing is not bound to the vicinity of the bushing and may be carried out remotely, where other electronic components of the monitoring unit are located.

According to another embodiment of the present disclosure, a method for providing a monitoring functionality of the battery module as described above is provided. Firstly, the bushing is fixed to the busbar. Secondly, the circuit board including the temperature sensor and the voltage signal line is placed onto the bushing such that a board opening in the circuit board and the bushing are aligned. Third, the bushing is fastened to the circuit board by the fixation element. Thereby, the busbar is electrically and thermally connected to the circuit board through the bushing.

In some embodiments, the method consists only of the above three steps. Thereby, the electrical, thermal, and mechanical connection of the circuit board is provided by only one fastening action. Accordingly, efficient assembly and cost reductions can be achieved. Further, in some embodiments, the board opening in the circuit board and the bushing opening in the bushing are aligned such that the fixation element can be inserted into both openings. The alignment reference point of the bushing may be the center of the bushing in a top view of the bushing. Then, the fixation element may be inserted into the aligned openings. Further, in some embodiments, one or more of these process steps may be automated.

Another embodiment of the present disclosure refers to a battery system including a plurality of battery modules as described above.

The battery system may include at least two battery modules. In another embodiment, the battery system includes at least three battery modules. In yet another embodiment, the battery system includes at least four battery modules.

Another embodiment of the present disclosure refers to an electric vehicle including the battery module or the battery system as described above.

The electric vehicle may include exactly one battery module or battery system. The module or system may be arranged centrally, at a lower position, in the vehicle. In another embodiment, the electric vehicle may include two or more battery modules or battery systems. These modules or systems may be arranged at different locations within the vehicle, allowing for a flexible weight and space adjustment.

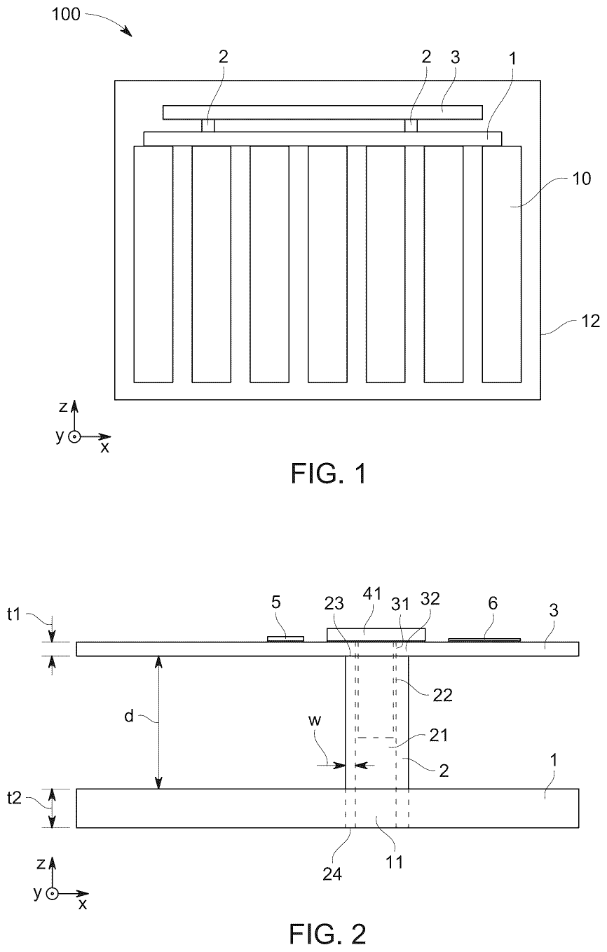

FIG. 1 is a schematic overview of a battery module 100 according to an embodiment of the present disclosure. The battery module 100 includes a housing 12, a plurality of battery cells 10, a busbar 1, and a circuit board 3. The busbar 1 is connected to the circuit board 3 by a bushing 2, as will be explained in more detail with reference to FIG. 2. At least one bushing 2 is between the circuit board 3 and the busbar 1. The position of the bushing 2 is not restricted by the position of the battery cells 10. Further, a monitoring unit may be included. The monitoring unit may be a battery disconnect unit, a battery management unit, or a cell supervision circuit, which process data received from the battery cells 10. The battery monitoring unit may include the circuit board 3. In the illustrated embodiment, seven battery cells 10 are shown. However, the number of battery cells 10 is not limited thereto and any suitable number of battery cells 10 may be included. Further, even though the battery cells 10 are illustrated as being arranged next to each other in a longitudinal direction (e.g., the x-direction) of the battery module 100, the arrangement direction and configuration is merely an example and the present disclosure is not limited thereto. For example, the battery cells 10 may be arranged in two or more stacked rows. Stacked refers to, for example, the y-direction in FIG. 1, which is perpendicular to the longitudinal x-direction and a vertical z-direction. The busbars 1 may be configured to fit the arrangement of the battery cells 10, such that terminals of multiple or all battery cells 10 are connected.

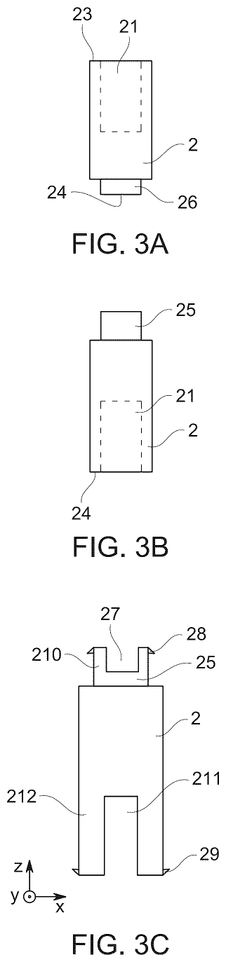

FIG. 2 is a schematic cross section of a bushing 2 according to an embodiment. The descriptions regarding FIG. 1 apply hereinafter. In the illustrated embodiment, the busbar 1 has an opening 11, into which the bushing 2 is inserted. The bushing 2 may have a bushing opening 21, which may extend through the bushing 2, that is, as a through-hole. The bushing 2 may be a hollow cylinder. However, in some embodiments, the bushing opening 21 may not extend entirely through the bushing 2 and may only partially extend from a first end face 23 of the bushing 2 facing the circuit board 3 towards the busbar 1. In some embodiments, the bushing opening 21 may be divided into two sections separated by a solid section of the bushing 2 (e.g., in a cross-sectional view of the bushing 2). The remaining wall thickness w of the bushing 2 around the bushing opening 21 may be in a range of about 0.5 mm to about 3 mm. In some embodiments, the wall thickness may be in a range of about 1 mm and about 2 mm. In one embodiment, the wall thickness may be in a range of about 1.3 mm and about 1.5 mm. The bushing opening 21 in the vicinity of the opening 11 in the busbar 1 is configured to provide (or to form) a force-fitting connection between the busbar 1 and the bushing 2. For example, the bushing may be press-fitted into the opening 11. A press-fit connection provides a contact surface along the entire opening 11 between the busbar 1 and the bushing 2. The bushing 2 may a metal bushing. This allows for a low thermal and electrical resistance between the parts. In some embodiments, the busbar 1 and the bushing 2 may be fixed in a materially bonded manner, such as, for example, welding, soldering, or gluing. Thereby, the contact surface between both parts increases and, therefore, the thermal and electrical conductivity further increases and mechanical strength is increased. Other connection methods will be discussed below with reference to FIGS. 3A and 3B, which could also be applied to the illustrated embodiment. The bushing 2 has a first end face 23 and a second end face 24, which may be parallel to each other. The distance between both end faces 23 and 24 may be equivalent to the length of the bushing 2.

The bushing 2 supports the circuit board 3 at its first end face 23. The circuit board 3 has a board opening 31 for fixation of the circuit board 3 to the bushing 2. In one embodiment, the board opening 31 in the circuit board 3 is at least as large as the bushing opening 21. However, the board opening 31 is not larger than an overall thickness (e.g., in the x-y-plane) of the bushing 2. For example, the first end face 23 forms a support and/or contact face for the circuit board 3. Through this support and/or contact face, electric and thermal contact is established between both parts. Further, a fixation element (e.g., a mechanical fixation element) is provided to fix the circuit board 3 to the bushing 2. The fixation element may be a separate part or may be integrally formed with the circuit board 3 or the bushing 2. In the illustrated embodiment, the fixation element is a screw 41. Thereby, a screwing connection is used to mount the electronics, that is, the circuit board 3, directly to the busbar 1. The bushing opening 21 may have a corresponding inner thread 22. However, the screw 41 may also be a self-cutting (or self-tapping) screw so that the bushing opening 21 may be provided (or formed) without an inner thread 22. In other embodiments, the fixation element may be a bolt or a rivet. The fixation element fixes the circuit board 3 to the bushing 2 such that the circuit board 3 is securely fixed. The fixation element also ensures thermal and electrical conductivity between the bushing 2 and the circuit board 3. With the screwing connection, all temperature and high-voltage voltage sensing connections are already provided and additional mounting steps are omitted. The circuit board 3 includes a temperature sensor 5 configured to contact the busbar 1 through the bushing 2 in a thermally conducting manner. For example, the temperature sensor 5 is provided for measuring the temperature of the busbar 1 without directly contacting the busbar 1. For the temperature measurement to be accurate, the temperature sensor 5 is positioned in the vicinity of the board opening 31. The temperature sensor 5 may be positioned on the upper side or the lower side of the circuit board 3. The vicinity of the board opening 31 may refer to a position of the temperature sensor 5 within a circle having a radius in a range of about 0.5 mm to about 4 mm. In some embodiments, the radius may be in a range of about 0.6 mm to about 1.5 mm. This ensures a small temperature difference between the contact face of the circuit board 3 with the bushing 2 and another contact face of the circuit board 3 with the temperature sensor 5. The temperature difference between both contact faces may be less than about 1K. In another embodiment, the temperature difference may be less than about 0.5K.

The circuit board 3 includes a voltage signal line 6 configured to contact the busbar 1 through the bushing 2 in an electrically conducting manner. Therefore, the voltage signal line 6 may contact the upper side and/or the lower side of the circuit board 3 at the board opening 31. Further, the voltage signal line 6 may extend on the upper side, lower side, and/or an interlayer of the circuit board 3. The voltage signal line 6 may be in direct contact with the bushing 2 or in intermediate contact over the fixation element. Additionally, the voltage signal line 6 may be a high voltage sensing line.

The bushing 2 spaces the circuit board 3 from the busbar 1 by a distance d. The distance d may be equal to or more than about 8 mm, equal to or more than about 10 mm, or equal to or more than about 12 mm. In some embodiments, the distance d may be at least twice a thickness t1 of the circuit board 3. Further, the distance d may be equivalent to the length of the bushing 2. In some embodiments, the distance d may be equivalent to the length of the bushing 2 minus a thickness t2 of the busbar 1. This may be the case when the bushing 2 extends through the busbar 1, and the second end face 24 is flush with the lower side of the busbar 1.

FIGS. 3A to 3C are schematic cross sections of bushings 2 according to other embodiments. The description of all previous figures applies accordingly, unless explicitly stated otherwise. The bushing 2 is fixed to the busbar 1 in a form-fitting manner, in a force-fitting manner, and/or in a materially bonded manner. The bushing 2 shown in FIG. 3A has a bushing opening 21 which only extends to a certain degree (or length) into the body of the bushing 2. For example, the solid body of the bushing 2, that is, a portion of the bushing 2 without a bushing opening 21, may be larger, that is, have a length of about 10%, about 20%, or about 30% of the distance d. However, the structure of the first end face 23 of the bushing 2 is identical to the structure shown in FIG. 2. The difference of this embodiment with that described above with reference to FIG. 2 is the structure of the second end face 24. Here, the second end face 24 is formed as a lower protrusion 26 having a smaller vertical extension (e.g., in the x-y-plane in FIG. 2) than the mid-portion and/or the top-portion of the bushing 2. In this embodiment, the opening in the busbar may be smaller than in the embodiment shown in FIG. 2 to fit the lower protrusion 26. The fit may be tight, for example, to provide a force-fitting connection, or may be loose to provide for rough positioning and subsequent fixation in a materially bonded manner. FIG. 3B is, compared to FIG. 3A, flipped by 180°. The second end face 24 is identical to the embodiment shown in FIG. 2. However, the top of the bushing 2 has an upper protrusion 25. The upper protrusion 25 may be provided with an outer thread, a through hole in a horizontal direction, and/or fixing grooves to which a fixation element can be connected. In this embodiment, the fixation element may be a nut, a clamp, a clip, etc. In some embodiments, the fixation element may be formed integrally, that is, the upper protrusion may have a conical shape configured for fixing the circuit board. The bushing 2 shown in FIG. 3C is similar to the bushing shown in FIG. 3B. However, the upper protrusion 25 is provided with at least one protrusion groove 27 (e.g., extending in the x-y-plane) extending through the upper protrusion 25 to form two protrusion legs 210. A plurality of protrusion grooves 27 may form a plurality of protrusion legs 210. The protrusion legs 210 may have a square cross-sectional shape and may have one or more first hooks 28 formed on their outer edge. The first hooks 28 may snap onto the upper side of the circuit board 3 to connect the circuit board 3 with the bushing 2. The hooks 28 are an example of a form-fitting fixation element. The protruding groove 27 provides flexibility to the protrusion legs 210 to bend inwardly and thereafter bend outwardly when the protrusion legs 210 have passed through the circuit board 3. At least one leg groove 211 is formed on the lower side of the bushing 2 as a through hole in the horizontal direction (e.g., in the x-y-plane) to form two or more lower legs 212 of the bushing 2. The lower legs 212 have, at their outer corners, one or more second hooks 29. Similar to the first hooks 28, the second hooks 29 latch onto the lower side of the busbar 1 when the lower legs 212 pass through the opening 11 in the busbar 1. The legs 212 may additionally be fixed in a materially bonded manner. Additionally, the described features of the embodiments shown in FIGS. 2 to 3C regarding the bushing may be combined with each other or may be altered to realize similar embodiments.

FIG. 4 is a schematic perspective view of a bushing 2 between a busbar 1 and a circuit board 3. The structure shown in FIG. 4 is consistent with FIGS. 1 to 3C, and all of the previous descriptions apply accordingly. However, certain parts, such has the fixation element, the temperature sensor 5, details of the bushing 2, or the voltage signal line 6 may be omitted for convenience. The busbar 1 may be bent. This may be due to a certain battery cell 10 arrangement or for reaching terminals of a battery module 100. Further, the circuit board 3 may have a larger extension in a width direction than the busbar 1 and may contact a plurality of busbars 1 by a plurality of bushings 2. In such an embodiment, a plurality of temperature sensors 5 and a plurality of voltage signal lines 6 may be present.

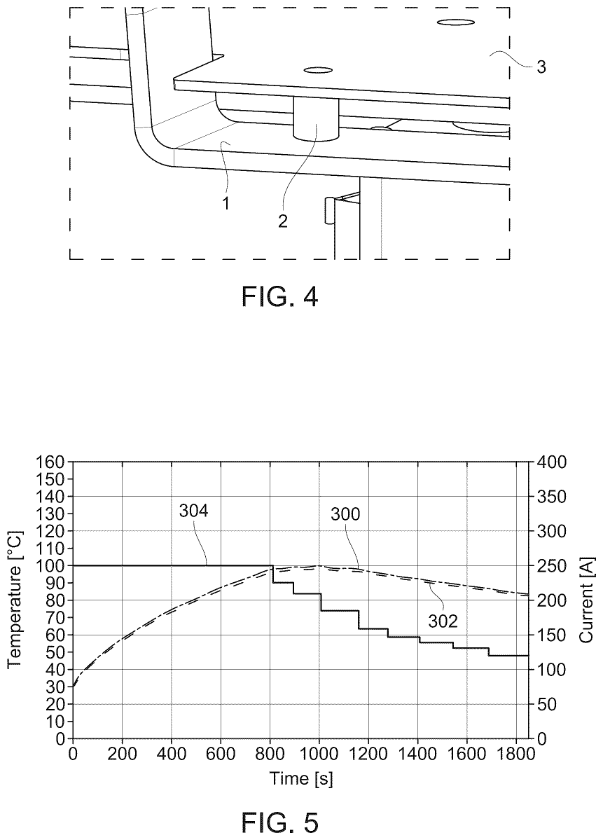

FIG. 5 is a graph of the temperature change over time on the circuit board 3 at a circuit board heat spot on the circuit board 3 directly adjacent to the connection point of the bushing 2 with the circuit board 3 and at the temperature sensor 5 remote from the circuit board heat spot. The bushing 2 conducts heat from the busbar 1 to the circuit board 3, and the circuit board 3 transfers the heat to the temperature sensor 5. The circuit board 3 heat spot may be a board connection section 32 (see, e.g., FIG. 2). This plot is obtained by FEM analysis on a circuit board 3 around a bushing heat spot of a bushing 2 as described above. The temperature curve at the circuit board 3 heat spot is indicated by numeral 300, the temperature curve at the temperature sensor 5 is indicated by numeral 302, and a charging current curve is indicated by numeral 304. At t=0, the temperature is at about 30° C. The battery module 100 is charged at a charging current of 100 A, which causes an increase in temperature of the busbar 1 and, in turn, of the circuit board 3 heat spot on the printed circuit board 3 and the temperature sensor 5. The temperature difference in this example is about less than about 2K at the maximum temperature of about 100° C. For example, the temperature difference between a section of the circuit board 3 in direct contact with the bushing 2 and a section of the circuit board 3 in direct contact with the temperature sensor 5 is less than about 2K. Compared to the temperature measured directly at the circuit board 3 heat spot, the temperature difference may be less than about 3%. In some embodiments, the temperature difference may be less than about 2%. The temperature difference may be reduced by placing the temperature sensor 5 closer to the circuit board 3 heat spot. Then, the temperature difference may even be smaller, such as about 0.5K. When the temperature difference is small, the time delay between a temperature rise at the busbar 1 and the sensing of the temperature by the temperature sensor 5 is negligible.

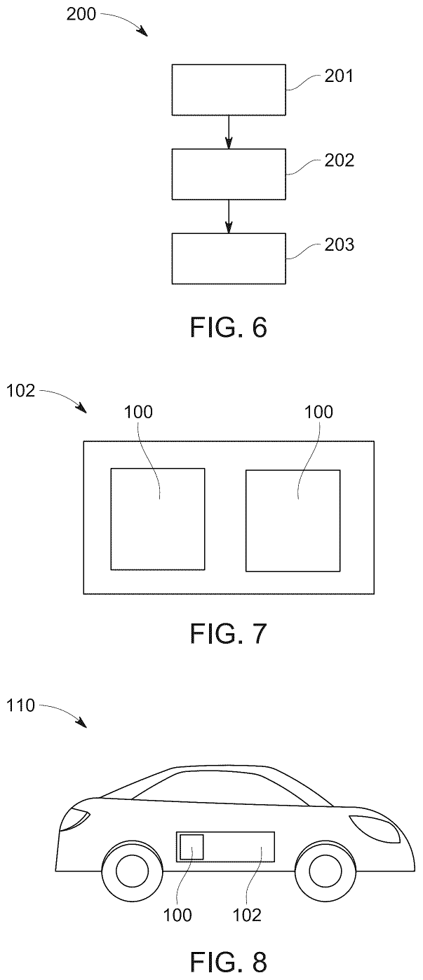

FIG. 6 is a flow-chart describing a method 200 for providing a monitoring functionality for a battery module 100. The description of the previous figures may be applied accordingly. The method includes, in a first step 201, the fixing of the bushing 2 to the busbar 1. As described above regarding FIGS. 2 to 3C, the bushing 2 may be fixed to the busbar 1 in various manners. In a second step 202, the circuit board 3 including the temperature sensor 5 and the voltage signal line 6 is placed onto the bushing 2 such that a board opening 31 in the circuit board 3 and the bushing 2 are aligned. When the bushing 2 has the bushing opening 21 at the first end face 23 of the bushing 2, both openings align and the fixation element extends into both openings. When the bushing 2 has the upper protrusion 25, this protrusion extends through the board opening 31 in the circuit board 3 and the fixation element may go onto or into the upper protrusion 25. In both configurations, in a third step 203, the bushing 2 is fixed to the circuit board 3 by a fixation element. Thereby, the circuit board 3 is thermally and electrically connected to the busbar 1 by the bushing 2. No additional mounting steps are required and, therefore, easy installation is achieved.

FIG. 7 is a schematic view of a battery system 102 according to an embodiment of the present disclosure. The description of all previous figures applies accordingly. In this embodiment, the battery system 102 includes two battery modules 100, but the battery system 102 is not limited thereto. The battery system 102 may also include three, four, or more battery modules 100.

FIG. 8 is a schematic view of an electric vehicle 110 according to an embodiment of the present disclosure. The description of all previous figures applies accordingly. In this embodiment, the electric vehicle 110 includes at least a battery module 100 for supplying the electrical vehicle 110 with energy. In another embodiment, the electric vehicle 110 may include a battery system 102. Battery modules 100 of the battery system 102 may be distributed within the electric vehicle 110.

### SOME REFERENCE NUMERALS

| | | | |
|---|---|---|---|
| 1 | busbar | 11 | opening |
| 2 | bushing | 21 | bushing opening |
| 22 | internal thread | 23 | first end face |
| 24 | second end face | 25 | upper protrusion |
| 26 | lower protrusion | 27 | protrusion groove |
| 28 | first hook | 29 | second hook |
| 210 | protrusion leg | 211 | leg groove |
| 212 | lower leg | 3 | circuit board |
| 31 | board opening | 32 | board connecting section |
| 41 | screw | 5 | temperature sensor |
| 6 | voltage signal line | 10 | battery cell |
| 12 | housing | 100 | battery module |
| 102 | battery system | 110 | electric vehicle |

| | |
|---|---|
| 200 | method for providing a monitoring |
| | functionality for a battery module |
| 201 | fixing of the bushing to the busbar |
| 202 | placing the circuit board onto the bushing |
| 203 | fastening the bushing to the circuit board |
| 300 | temperature curve at board heat spot |
| 302 | temperature curve at temperature sensor |
| 304 | charging current curve |

What is claimed is:

1. A battery module comprising:
a plurality of battery cells;
a busbar contacting the plurality of battery cells;
a thermally and electrically conductive bushing thermally and electrically connected to the busbar; and
a circuit board fixed to the bushing by a fixation element such that the bushing spaces the circuit board from the busbar, the circuit board comprising:
a temperature sensor in thermal contact with the busbar through the bushing; and
a voltage signal line in electrical contact with the busbar through the bushing.

2. The battery module as claimed in claim 1, wherein the bushing is fixed to the busbar in a form-fitting manner, in a force-fitting manner, and/or in a materially bonded manner.

3. The battery module as claimed in claim 2, wherein the force-fitting manner comprises press-fitting the bushing into an opening in the busbar.

4. The battery module as claimed in claim 1, wherein the circuit board has a thickness and the bushing spaces the circuit board from the busbar by at least twice the thickness of the circuit board.

5. The battery module as claimed in claim 1, wherein the bushing has a bushing opening extending from a first end face of the bushing facing the circuit board towards the busbar.

6. The battery module as claimed in claim 5, wherein the bushing opening extends from the first end face to a second end face of the bushing opposite to the first end face.

7. The battery module as claimed in claim 1, wherein the bushing is a hollow cylinder having a bushing opening.

8. The battery module as claimed in claim 7, wherein the fixation element comprises a screw, a bolt, a nut, a splint, or a rivet.

9. The battery module as claimed in claim 1, wherein the circuit board forms part of a battery disconnect unit, a battery management unit, and/or a cell supervision circuit.

10. The battery module as claimed in claim 1, wherein a temperature difference between a section of the circuit board in direct contact to the bushing and a section of the circuit board in direct contact to the temperature sensor is less than 1K.

11. The battery module as claimed in claim 1, wherein the bushing is a metal bushing.

12. The battery module as claimed in claim 1, wherein the voltage signal line is a high voltage sensing line.

13. A method for providing a monitoring functionality of the battery module as claimed in claim 1, the method comprising:
fixing the bushing to the busbar;
placing the circuit board comprising the temperature sensor and the voltage signal line onto the bushing such that a board opening in the circuit board and the bushing are aligned; and
fastening the bushing to the circuit board by the fixation element to electrically and thermally connect the busbar to the circuit board through the bushing.

14. A battery system comprising a plurality of the battery modules as claimed in claim 1.

15. An electric vehicle comprising the battery system as claimed in claim 14.

16. An electric vehicle comprising the battery module as claimed in claim 1.
